(19) United States
(12) Patent Application Publication
(10) Pub. No.: US 2024/0176041 A1
(43) Pub. Date: May 30, 2024

(54) CO2 I-BOTS FOR SEAL INTEGRITY MONITORING

(71) Applicant: SAUDI ARABIAN OIL COMPANY, Dhaharan (SA)

(72) Inventors: Abdallah A. Alshehri, Dhahrah (SA); Klemens Katterbauer, Dhahran (SA); Abdulaziz S. Al-Qasim, Dammam (SA)

(21) Appl. No.: 18/059,786

(22) Filed: Nov. 29, 2022

(51) Int. Cl. G01V 11/00; E21B 47/12; G06N 20/00

(52) U.S. Cl. CPC G01V 11/002; E21B 47/138; G06N 20/00; E21B 41/0064

(57) ABSTRACT

Systems and methods for monitoring a hydrocarbon reservoir for escaped CO₂ are disclosed. The methods include deploying a plurality of CO₂ i-Bot sensors downhole into an observation well located above a CO₂ injection zone, establishing communication among the plurality of CO₂ i-Bot sensors, between the plurality of CO₂ i-Bot sensors and a base station, and between the base station and a central processing location. The methods also include collecting a plurality of environmental data and sensor data from the plurality of CO₂ i-Bot sensors, and training a machine learning algorithm to predict the plurality of environmental data and sensor data of the plurality of CO₂ i-Bot sensors. Furthermore, the methods include determining an optimized number of CO₂ i-Bot sensors that minimizes a quantity of power consumption and maximizes an area of coverage of the hydrocarbon reservoir by the plurality of CO₂ i-Bot sensors using the trained machine learning algorithm.

### BACKGROUND

Carbon sequestration in reservoirs and aquifers represents a solution to the global challenge of reducing overall emissions of carbon dioxide (CO₂) into the atmosphere. Enhanced oil recovery (EOR) provides a means to increase oil production by using CO₂ to drive out unproduced hydrocarbons from rock pores. Both of these applications require the injection of CO₂ into the subsurface through wells along with subsequent monitoring to ensure that the gas does not escape.

Current methods for monitoring CO₂ in sequestration and EOR projects typically use fixed downhole sensors, monitoring at the well head, or aerial monitoring to determine whether it is escaping.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments related to methods for monitoring a hydrocarbon reservoir for escaped CO₂ are disclosed. The methods include deploying a plurality of CO₂ i-Bot sensors downhole into an observation well located above a CO₂ injection zone, establishing communication among the plurality of CO₂ i-Bot sensors, between the plurality of CO₂ i-Bot sensors and a base station, and between the base station and a central processing location. The methods also include collecting a plurality of environmental data and sensor data from the plurality of CO₂ i-Bot sensors, and training a machine learning algorithm to predict the plurality of environmental data and sensor data of the plurality of CO₂ i-Bot sensors. Furthermore, the methods include determining an optimized number of CO₂ i-Bot sensors that minimizes a quantity of power consumption and maximizes an area of coverage of the hydrocarbon reservoir by the plurality of CO₂ i-Bot sensors using the trained machine learning algorithm.

In general, in one aspect, embodiments related to a non-transitory computer readable medium storing instructions executable by a computer processor with functionality for deploying a plurality of CO₂ i-Bot sensors downhole into an observation well located above a CO₂ injection zone, and establishing communication among the plurality of CO₂ i-Bot sensors, between the plurality of CO₂ i-Bot sensors and a base station, and between the base station and a central processing location. The instructions also include functionality for collecting a plurality of environmental data and sensor data from the plurality of CO₂ i-Bot sensors, and training a machine learning algorithm to predict the plurality of environmental data and sensor data of the plurality of CO₂ i-Bot sensors. Furthermore, the instructions also include functionality for determining an optimized number of CO₂ i-Bot sensors that minimizes a quantity of power consumption and maximizes an area of coverage of the hydrocarbon reservoir by the plurality of CO₂ i-Bot sensors using the trained machine learning algorithm.

In general, in one aspect, embodiments related to a system that optimizes an injection of CO₂ down a borehole into a hydrocarbon reservoir and monitors for escaped CO₂, including a plurality of CO₂ i-Bot sensors configured to traverse the borehole and monitor CO₂ in the hydrocarbon reservoir, and a base station operatively connected to the plurality of CO₂ i-Bot sensors, wherein the system is configured to establish communication among the plurality of CO₂ i-Bot sensors, and between the plurality of CO₂ i-Bot sensors and the base station. The system also includes a control center having a computer processor operatively connected to the plurality of CO₂ i-Bot sensors, the processor being configured to collect a plurality of environmental data and sensor data from the plurality of CO₂ i-Bot sensors, train a machine learning algorithm to predict the plurality of environmental data and sensor data of the plurality of CO₂ i-Bot sensors using the collected environmental and sensor data, and determine an optimized number of CO₂ i-Bot sensors that minimizes a quantity of power consumption and maximizes an area of coverage of the hydrocarbon reservoir by the plurality of CO₂ i-Bot sensors using the trained machine learning algorithm.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a drilling system in accordance with one or more embodiments.

FIG. 2 shows an enhanced oil recovery project with injection and production wells, CO₂ i-Bot sensors, a base station, and central processing location according to one or more embodiments.

FIG. 3 shows a CO₂ storage project with injection wells, CO₂ i-Bot sensors, a base station, and central processing location according to one or more embodiments.

FIG. 4 shows an artificial neural network (ANN) in accordance with one or more embodiments.

FIG. 5 shows a flowchart for a long short-term memory artificial neural network according to one or more embodiments.

FIG. 6 shows a flowchart according to one or more embodiments.

FIG. 7 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments disclosed herein relate to an innovative Internet of Things (IoT) and data driven framework to enhance reservoir sustainability and improve CO₂ sequestration via subsurface reservoir sensors (CO₂ i-Bots) and optimize injection, utilizing artificial intelligence (AI) and robotics. The framework disclosed herein utilizes subsurface miniaturized sensors (CO₂ i-Bots) for CO₂ and fluid monitoring, where the sensor data are in real-time connected to an AI driven optimization module for the optimization of the CO₂ storage in aquifers and CO₂-EOR projects. In one or more embodiments, the specific technology disclosed herein focuses on the optimization of sensor utilization of sufficient reservoir sensing coverage. In one or more embodiments, the framework is based on a deep learning long short-term memory (LSTM) framework that first trains the LSTM network on a training set, and then subsequently utilizes the LSTM network in optimizing the number of sensors to maximize longevity and spatial coverage of reservoir sensing.

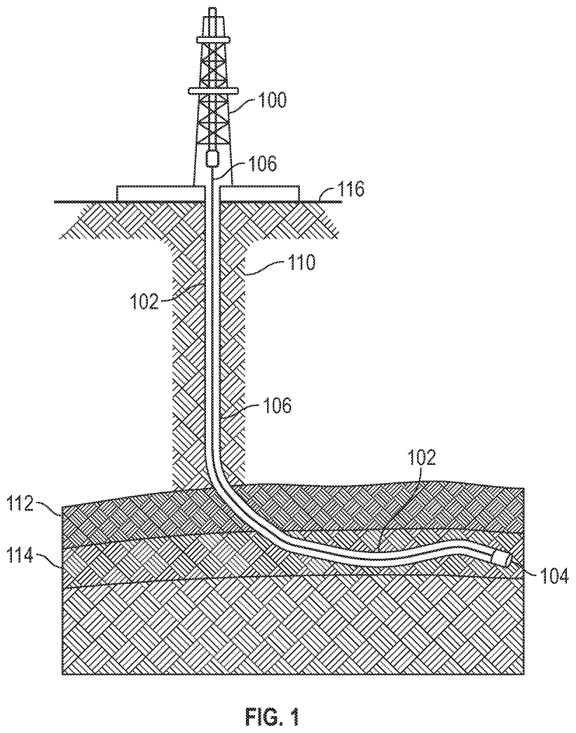

FIG. 1 illustrates a system in accordance with one or more embodiments. Specifically, FIG. 1 shows a well (102) that may be drilled by a drill bit (104) attached by a drillstring (106) to a drill rig (100) located on the surface of the earth (116). The borehole corresponds to the uncased portion of the well (102). The borehole trajectory is the path in three-dimensional space that the well is drilled through the subsurface. The borehole of the well (102) may traverse a plurality of overburden layers (110) and one or more cap-rock layers (112) to an aquifer or hydrocarbon reservoir (114). One or more wells (102) may be drilled to produce hydrocarbons, to re-inject produced water or gas back into an aquifer or hydrocarbon reservoir (114), or to monitor for escaping gases or fluids. In the case of re-injection, cap-rock layers (112) serve as a seal above the aquifer or hydrocarbon reservoir (114) and prevent the escape of gases and fluids. Observation wells typically are located above the cap-rock layers (112). In the case of CO₂ storage, fluids in the observation wells are examined for the presence of CO₂ gas. Among the methods for extracting fluids to examine for the presence of CO₂ are gas lift (changing the pressure in the well to cause upward flow), a submersible pump (which also forces fluids to the surface), and vacuum sampling (which seals a sample in the borehole, thus maintaining borehole pressure). The latter method tends to perform better, since lowering the pressure causes fluids to lose dissolved gases like CO₂. Another way to measure the presence of CO₂ in observation wells fluids is to place sensors in situ into the borehole. This method avoids the problem of losing dissolved gases before examining a sample and is the approach presented in the method described below.

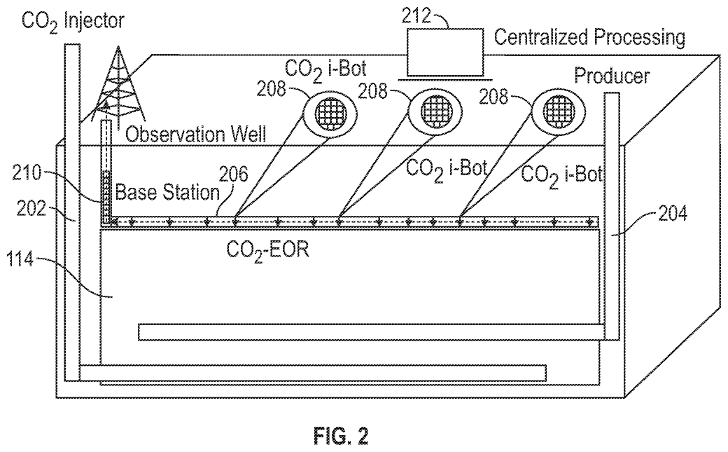

According to one more embodiments, FIG. 2 depicts a three-dimensional volume of the subsurface where a hydrocarbon reservoir (114) is undergoing EOR. In this embodiment, a first injection well (202) has been drilled into the lower part of a hydrocarbon reservoir (114). It injects CO₂ into the hydrocarbon reservoir (114) in order to drive hydrocarbons towards a second production well (204) located above the first injection well (202). An observation well (206) is positioned at the top of the hydrocarbon reservoir (114); CO₂ i-Bots (208) have been deployed into this observation well (206) for monitoring purposes and are distributed through the length of the observation well (206). The CO₂ i-Bots may be deployed by dropping them into the observation well (206), where they get swept into the formation. Alternatively, they may be deployed over a pre-selected area in the borehole based on a desired quantity per area size. In other embodiments, the CO₂ i-Bots may be physically affixed or attached against the formation or borehole wall.

CO₂ i-Bots are miniaturized sensors that enable in situ CO₂ and fluid monitoring, where the sensor data are received in real-time and the CO₂ i-Bots (208) are connected to an AI module to optimize their power usage and spatial coverage. In one or more embodiments, the AI method used to optimize the CO₂ i-Bots (208) is a form of machine learning (ML) known as an LSTM network (500), which uses deep neural network (400) to monitor the state of the CO₂ i-Bots (208).

In one or more embodiments, the CO₂ i-Bots (208) follow the IoT paradigm, where each sensor has its own independent software, power harvesting ability, and processing ability, thus allowing them to communicate in multi-hop fashion with each other and with a base station (210) wirelessly through a magnetic induction technique. More specifically, after they are placed inside the observation well (206), CO₂ i-Bots (208) establish CO₂ i-Bot to CO₂ i-Bot connectivity using an IoT protocol, for example, to start communicating the sensed data, including location coordinates, amongst each other, until the information reaches the base station (210). The base station (210) consists of a large antenna connected to an aboveground gateway. The gateway transmits data to a central processing location (212), where information is recorded.

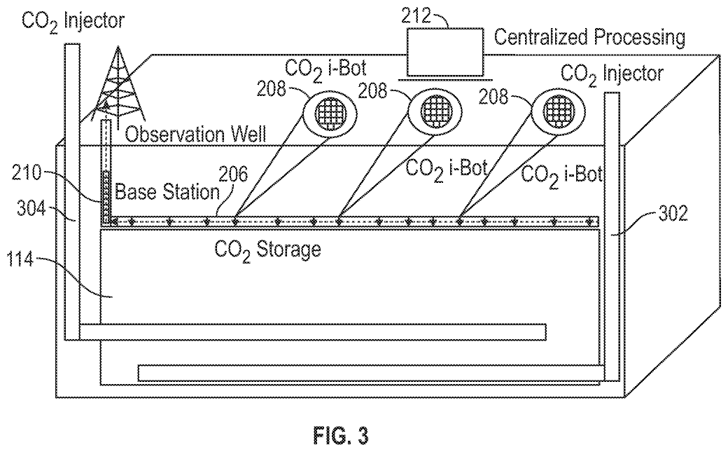

In one or more embodiments, FIG. 3 depicts a three-dimensional volume of the subsurface where an aquifer or hydrocarbon reservoir (114) is undergoing CO₂ storage. In what follows, hydrocarbon reservoir (114) refers to the subsurface geologic storage formation, regardless of whether it was originally an aquifer or hydrocarbon reservoir (114). In this embodiment, a first injection well (302) has been drilled into the lower part of the hydrocarbon reservoir (114), and a second injection well (304) has been drilled into the middle part of the hydrocarbon reservoir. For the purposes of CO₂ storage, there is no attempt to retrieve natural resources from the hydrocarbon reservoir (114); the goal is to maximize the amount of CO₂ injected into the subsurface. An observation well (206) is positioned at the top of the hydrocarbon reservoir (114). Analogous to the case of EOR, CO₂ i-Bots (208) have been deployed in this observation well (206) for monitoring purposes and are distributed throughout the length of the observation well (206). The CO₂ i-Bots (208) function analogously for CO₂ storage as they do for an EOR application.

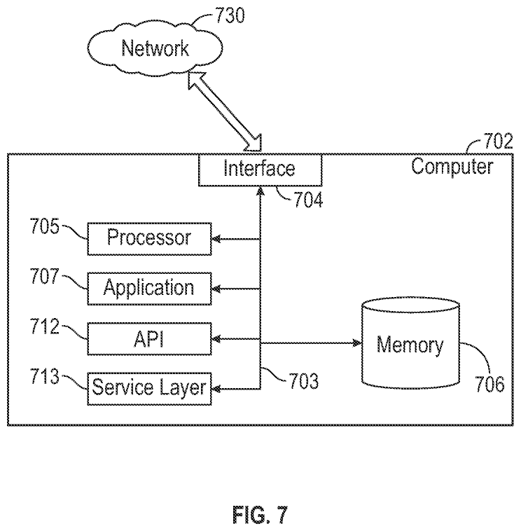

In one or more embodiments, the sensor data collected by the CO₂ i-Bots (208) is used to monitor the integrity of cap rock layers (112), i.e., their ability to contain injected CO₂, and detect any inadvertent leakages. For example, sensor data may include, but it not limited to: temperature measurements, location information, pressure measurements, and fluid phase data. Collected pressure and temperature data may also be used to generate lateral profile which will help to detect anomalies in the hydrocarbon reservoir (114). The recorded data are processed by a computing device, for example as shown in FIG. 7, in a Hadoop framework and then collected in a Non-SQL database.

After insertion into the observation well (206), the CO₂ i-Bots (208) must be first be processed and outliers (malfunctioning sensors) must be removed. Inconsistent data must also be removed. Inconsistency may arise from erroneous measurements, such as extreme high signal quality that is very unlikely or ultra-high-power utilization which may indicate a broken power module. For the outlier removal, both moving window and z-score outlier removal methods are utilized.

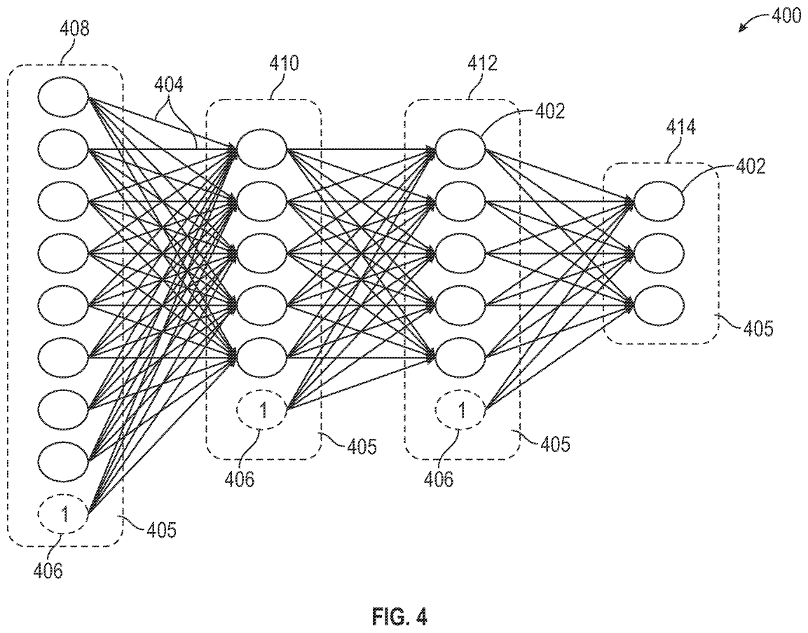

FIG. 4 shows a neural network, a common AI method used in ML applications for prediction/inference. At a high level, a neural network (400) may be graphically depicted as comprising nodes (402), where here any circle represents a node, and edges (404), shown here as directed lines. The nodes (402) may be grouped to form layers (405). FIG. 4 displays four layers (408, 410, 412, 414) of nodes (402) where the nodes (402) are grouped into columns, however, the grouping need not be as shown in FIG. 4. The edges (404) connect the nodes (402). Edges (404) may connect, or not connect, to any node(s) (402) regardless of which layer (405) the node(s) (402) is in. That is, the nodes (402) may be sparsely and residually connected. A neural network (400) will have at least two layers (405), where the first layer (408) is considered the “input layer” and the last layer (414) is the “output layer”. Any intermediate layer (410, 412) is usually described as a “hidden layer”. A neural network (400) may have zero or more hidden layers (410, 412) and a neural network (400) with at least one hidden layer (410, 412) may be described as a “deep” neural network or as a “deep learning method”. In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The edge numerical values, or even the edges (404) themselves, are often referred to as “weights” or “parameters”. While training a neural network (400), numerical values are assigned to each edge (404). Additionally, every node (402) is associated with a numerical variable and an activation function. Activation functions are not limited to any functional class, but traditionally follow the form:

A=ƒ(Σ_{i∈(incoming)}[(node value)ᵢ(edge value)ᵢ]), Equation (1)

where i is an index that spans the set of “incoming” nodes (402) and edges (404) and ƒ is a user-defined function. Incoming nodes (402) are those that, when viewed as a graph (as in FIG. 4), have directed arrows that point to the node (402) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (402) in a neural network (400) may have a different associated activation function. Often, as a shorthand, activation functions are described by the function ƒ by which it is composed. That is, an activation function composed of a linear function ƒ may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (406), displayed in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training, the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Recall, that a given data set will be composed of inputs and associated target(s), where the target(s) represent the “ground truth”, or the otherwise desired output. The neural network (400) output is compared to the associated input data target(s). The comparison of the neural network (400) output to the target(s) is typically performed by a so-called “loss function”; although other names for this comparison function such as “error function” and “cost function” are commonly employed. Many types of loss functions are available, such as the mean-squared-error function, however, the general characteristic of a loss function is that the loss function provides a numerical evaluation of the similarity between the neural network (400) output and the associated target(s). The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target(s) over the data set. Thus, the loss function is used to guide changes made to the edge (404) values, typically through a process called “backpropagation”.

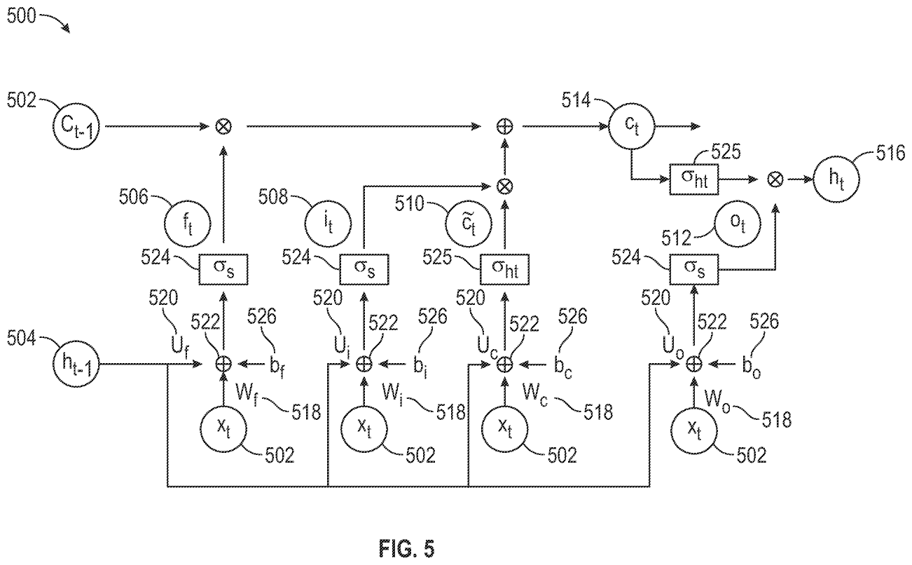

FIG. 5 depicts, in one or more embodiments, an LSTM network (500), a particular type of neural network (500) that is used to process data from the CO₂ i-Bots (208) in real time, in accordance with embodiments disclosed herein. LSTM networks (500), are a useful form of ML for modeling time-dependent systems. They avoid some problems associated with the backpropagation algorithm that are used to train neural networks, such as vanishing gradients that result from finite-precision mathematical errors. The LSTM network (500) simultaneously predicts the CO₂ concentration, pressure, temperature, location, signal quality, reliability, and power utilization of the CO₂ i-Bots (208) from the sensor and environment data they transmit. In one or more embodiments, the LSTM network (500) takes into account, for the input weighting, the expectation of the measurement quality for each group of sensors. This adaptive weighting is based on the sensor data quality and accuracy, which is inferred by the variations in the measurement data. The results of the LSTM network (500) are integrated into an optimization framework that selects sensors to be disabled; when actively applied to the CO₂ i-Bots (208), it minimizes the number of active sensors while maintaining sufficient reservoir coverage. In this way the LSTM network (500) seeks to trade off the quality of transmitted data with the power usage of the sensors, thereby achieving robust estimates of in situ variables (i.e., temperature, pressure, and fluid phase). The results of the LSTM network (500) and the subsequent optimization framework suggests the adjustment of the CO₂ i-Bots (208) in situ (i.e., turning some off or on) to ensure sufficient reservoir sensing coverage and maximal longevity.

In this particular embodiment, data pertaining to CO₂ concentration, temperature, pressure, location, signal quality, reliability, and power utilization from the CO₂ i-Bots (208) are received at the central processing location (212) at a particular moment in time, t, and are represented by the vector xₜ (502). xₜ (502) must be processed through the LSTM network (500) to filter out noise and spurious measurements and update a memory cell vector, cₜ (514), which models the estimated current state of the CO₂ concentration, temperature, and pressure that is being tracked by the CO₂ i-Bots (208). The LSTM network (500) accomplishes this by first sending xₜ (502) through several networks in parallel and recombining the results into output cₜ (514), along with hₜ (516), a hidden state vector whose purpose is to retain information in the system from one time step to the next that aids the LSTM network (500) in the modeling process. ƒₜ, iₜ, \tilde{c}ₜ, and oₜ (506, 508, 510, 512) are intermediate vectors produced by the LSTM network (500) in order to update both cₜ (514) and hₜ (516) at each time step, t. ƒₜ (506) is known as the “forget gate's activation vector”. It serves to “forget” information that leads to vanishing gradients in the backpropagation algorithm. iₜ (508) is called “input gate's activation vector”, eₜ (510) is called the “cell input activation vector”, and oₜ (512) is called the “output gate's activation vector”.

The implementation of the LSTM network (500) for processing the CO₂ i-Bot (208) data for this particular embodiment is as follows: The input vector xₜ (502) is operated upon a set of matrices, W_{q} (518), where q {ƒ, i, \tilde{c}, o}. Similarly, hₜ (516) is operated upon by another set of matrices, U_{q} (520). Each entry of these matrices corresponds to an edge (404) of a neural network, as illustrated in of FIG. 4. The output of these matrix-vector products is recombined in the following way to produce the intermediate vectors:

ƒₜ=σₛ(W_{ƒ}xₜ+U_{ƒ}hₜ₋₁+b_{ƒ}),

iₜ=σₛ(Wᵢxₜ+Uᵢhₜ₋₁+bᵢ),

\tilde{c}ₜ=σₕₜ(W_{\tilde{c}}xₜ+U_{\tilde{c}}hₜ₋₁+b_{\tilde{c}}),

oₜ=σₛ(Wₒxₜ+Uₒhₜ₋₁+bₒ),

where σₛ (524) is the sigmoid nonlinear operation, σₕₜ (525) is the hyperbolic tangent nonlinear operation, and the vectors b_{q} (526), where q:={ƒ, i, \tilde{c}, o}, are bias nodes (406).

After applying the matrices W_{q} (518) and U_{q} (520) to the vectors xₜ (502) and hₜ₋₁ (504), the result is summed with the bias vector (522), and the nonlinear operations are applied (524, 525) to create the intermediate vectors, ƒₜ, iₜ, \tilde{c}ₜ, and oₜ (506, 508, 510, 512). The intermediate vectors (506, 508, 510, 512) are recombined in the following way to produce the cell vector cₜ (514) and hidden vector hₜ (516):

cₜ=ƒₜ⊗cₜ₋₁+iₜ⊗\tilde{c}ₜ,

hₜ=oₜ⊗σₕₜ(cₜ),
where ⊗ denotes the Hadamard product, i.e., element-by-element multiplication.

The structure of LSTM networks has proven to be effective in many applications for modeling time-series data; it is capable of incorporating new measurements, while retaining memory of old measurements in the prediction of variables at a subsequent time step. This structure allows it to continually process CO₂ i-Bot (208) data in real time, eliminating noise as it predicts the true state of CO₂, temperature, pressure, and location in the observation wells (206) along with signal quality, reliability, and power utilization of the sensors themselves.

Similar to other neural networks, the LSTM network (500) must be trained on a training data set before application, using the backpropagation algorithm to minimize prediction error and thereby determine the weights in the matrices. This training is done first with a training set of CO₂ i-Bot (208) sensor data obtained from CO₂ i-Bot (208) in a laboratory setting that mimics borehole conditions. Next, the training is repeated in a well-studied test training site. The LSTM network (500) is periodically re-trained in the subsurface environment when reference information is available. Expert information is incorporated into the LSTM network (500) during training in order to improve its prediction capability. The expert information takes the form of knowledge in recognizing spurious/unrealistic readings and minimizing their impact on the output of the LSTM network (500). The LSTM network (500) is then used in an automated fashion to constantly process the signals transmitted to the central processing location (212) from the base station (210) and predict the state of the CO₂ i-Bot (208) sensors. The quality of the LSTM network (500) is examined periodically, utilizing feature importance quantification techniques to evaluate its quality. Feature importance quantification utilizes Shapely or Lime values, which enable the quantification of the impact of each input feature on the quantities being estimated by the LSTM network (500). If the LSTM network (500) is not deemed to be performing satisfactorily, it is retrained.

Once the LSTM network (500) has predicted the environmental variables and the internal state of the sensors, the results may be fed into an optimization procedure that seeks to minimize the number of active sensors while simultaneously maximizing spatial coverage, sensor quality, and sensor reliability. Applying the results of the LSTM network (500) and the optimization framework for sensor selection to the management of the CO₂ i-Bots (208) minimizes the number of active sensors subject to every part of the reservoir being covered by at least one sensor. It also ensures a reliability above 50% as well as a signal quality at least 70% of the best possible signal. Furthermore, high power-utilizing sensors with low battery state will be specifically targeted for deactivation. The application of the LSTM network (500) and the optimization framework to the CO₂ i-Bots (208) is re-performed in periodic intervals in order to determine the number of sensors that should be active.

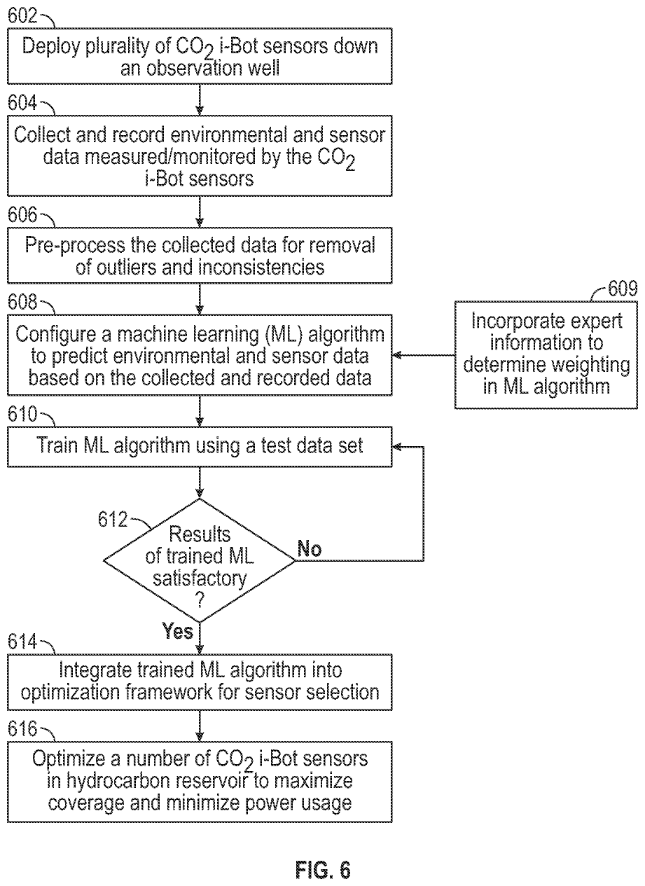

FIG. 6 presents a flowchart for the method of using CO₂ i-Bot (208) sensors to optimize sensor utilization for sufficient reservoir sensing coverage. It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In Step (602), CO₂ i-Bot (208) sensors are deployed in an observation well (206) above the injection zone in a hydrocarbon reservoir (114). Deployment may include, for example, fluid carrying the CO₂ i-Bot (208) to a desired location where the CO₂ i-Bot (208) parks itself, dropping the CO₂ i-Bots (208) into the borehole free form, or allowing the CO₂ i-Bots (208) to mobilize themselves and traverse the borehole until a desired location is reached. Upon deployment, or shortly thereafter, communication is established among the CO₂ i-Bots (208), between the CO₂ i-Bots and the base station (210), and between the base station (210) and a central processing location (212). Communication between the various components may be done sequentially in a particular order, or simultaneously. In one or more embodiments, the CO₂ i-Bots (208) employ IoT to communicate with each other after deployment.

The deployed CO₂ i-Bots (208) collect and record environmental and sensor data (Step 604). Environmental data may include a CO₂ concentration in the reservoir or a particular zone or region in the reservoir, a pressure, a temperature, and a location of the measurements. Sensor data may include a signal quality, a reliability, and a power utilization by the CO₂ i-Bots (208). The data collected and recorded is pre-processed (Step 606) to remove outlier data, using for example, moving window and/or z-score outlier removal methods. At this stage, inconsistent data from sensors are also removed. This may be done by observing the data and removing data that is clearly inconsistent with the majority of the remaining data. In Step 608, the LSTM network (500) is configured to predict environmental (CO₂ concentration, pressure, temperature, location) and sensor data (reliability, signal quality, power utilization). In order to configure the LSTM network (500), expert information is incorporated to improve prediction capability (Step 609). In one or more embodiments, the expert information may include information from human experts that analyzes data measurements, and compares formation properties with observed data. The expert information is used to determine/tune the adaptive weights of the LSTM network. For example, this information may lead to a lower weighting of data from sensors that are providing unreliable measurements and misleading information.

In Step 610, the LSTM network (500) is trained on a test set consisting of data collected from CO₂ i-Bots (208) in a laboratory setting. Whereas Step 608 establishes the model and framework, along with input weights, Step 610 evaluates the performance of the framework. In Step 612, the quality of the prediction results is evaluated utilizing an importance quantification technique, and the LSTM network (500) is retrained, if necessary. The importance quantification technique is essential as it enables the incorporation of trust and certainty into estimated parameters for subsequent decision making. High uncertainty will require remedial steps via adding/replacing CO₂ i-Bots (208) or additional survey techniques to have an accurate reservoir understanding. In Step 614, the predictions of the LSTM network (500) are integrated into an optimization framework that seeks to minimize the quantity of active CO₂ i-Bots (208) while supplying adequate coverage of sensors around the hydrocarbon reservoir (114).

In Step 616, the results obtained from the optimization framework are applied to the CO₂ i-Bots (208) to optimize the number of CO₂ i-Bots (208) that are used to monitor activity in the hydrocarbon reservoir (114). For example, some sensors are disabled to minimize power use while those that continue to function simultaneously provide sufficient spatial coverage for monitoring the presence of CO₂. Alternately, the optimization framework may indicate that sensors should be added to increase spatial coverage of the hydrocarbon reservoir (114). Optimization must be reperformed periodically to ensure that coverage of the reservoir is maximized while power usage is minimized.

FIG. 7 further depicts a block diagram of a computer system (702) used to provide computational functionalities associated with described algorithms, methods, functions, processes, flows, and procedures as described in this disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730). In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed is:

1. A method for monitoring a hydrocarbon reservoir for escaped CO₂, comprising:
deploying a plurality of CO₂ i-Bot sensors downhole into an observation well located above a CO₂ injection zone;
establishing communication among the plurality of CO₂ i-Bot sensors, between the plurality of CO₂ i-Bot sensors and a base station, and between the base station and a central processing location;
collecting a plurality of environmental data and sensor data from the plurality of CO₂ i-Bot sensors;
training a machine learning algorithm to predict the plurality of environmental data and sensor data of the plurality of CO₂ i-Bot sensors; and
determining an optimized number of CO₂ i-Bot sensors that minimizes a quantity of power consumption and maximizes an area of coverage of the hydrocarbon reservoir by the plurality of CO₂ i-Bot sensors using the trained machine learning algorithm.

2. The method of claim 1, wherein the plurality of environmental data comprises a CO₂ concentration, a pressure, a temperature, and a location, and wherein the plurality of sensor data comprises a signal quality, a reliability, and a power utilization.

3. The method of claim 1, wherein the monitoring for escaped CO₂ is for carbon sequestration or enhanced oil recovery (EOR).

4. The method of claim 1, wherein the machine learning algorithm is a long short-term memory (LSTM) network.

5. The method of claim 4, further comprising: integrating the LSTM network into an optimization framework configured for sensor selection to determine the optimized number of CO₂ i-Bot sensors.

6. The method of claim 5, wherein the optimization framework is configured to minimize a number of active CO₂ i-Bot sensors while ensuring that every producing part of the reservoir is covered by at least one CO₂ i-Bot sensor.

7. The method of claim 1, wherein communication among CO₂ i-Bot sensors is established using an Internet of Things (IoT) protocol.

8. A non-transitory computer readable medium storing instructions executable by a computer processor, the instructions comprising functionality for:
deploying a plurality of CO₂ i-Bot sensors downhole into an observation well located above a CO₂ injection zone;
establishing communication among the plurality of CO₂ i-Bot sensors, between the plurality of CO₂ i-Bot sensors and a base station, and between the base station and a central processing location;
collecting a plurality of environmental data and sensor data from the plurality of CO₂ i-Bot sensors;
training a machine learning algorithm to predict the plurality of environmental data and sensor data of the plurality of CO₂ i-Bot sensors; and
determining an optimized number of CO₂ i-Bot sensors that minimizes a quantity of power consumption and maximizes an area of coverage of a hydrocarbon reservoir by the plurality of CO₂ i-Bot sensors using the trained machine learning algorithm.

9. The non-transitory computer readable medium of claim 8, wherein the plurality of environmental data comprises a CO₂ concentration, a pressure, a temperature, and a location, and wherein the plurality of sensor data comprises a signal quality, a reliability, and a power utilization.

10. The non-transitory computer readable medium of claim 8, wherein the monitoring for escaped CO₂ is for carbon sequestration or for enhanced oil recovery (EOR).

11. The non-transitory computer readable medium of claim 8, wherein the machine learning algorithm is a long short-term memory (LSTM) network.

12. The non-transitory computer readable medium of claim 11, wherein the instructions further comprise functionality for: integrating the LSTM network into an optimization framework configured for sensor selection to determine the optimized number of CO₂ i-Bot sensors.

13. The non-transitory computer readable medium of claim 12, wherein the optimization framework is configured to minimize a number of active CO₂ i-Bot sensors while ensuring that every producing part of the reservoir is covered by at least one CO₂ i-Bot sensor.

14. The non-transitory computer readable medium of claim 8, wherein communication among CO₂ i-Bot sensors is established using an Internet of Things (IoT) protocol.

15. A system optimizing an injection of CO₂ down a borehole into a hydrocarbon reservoir and monitoring for escaped CO₂, comprising:
a plurality of CO₂ i-Bot sensors configured to traverse the borehole and monitor CO₂ in the hydrocarbon reservoir;
a base station operatively connected to the plurality of CO₂ i-Bot sensors;
wherein the system is configured to establish communication among the plurality of CO₂ i-Bot sensors, and between the plurality of CO₂ i-Bot sensors and the base station;
a control center having a computer processor operatively connected to the plurality of CO₂ i-Bot sensors, the processor being configured to:
collect a plurality of environmental data and sensor data from the plurality of CO₂ i-Bot sensors;
train a machine learning algorithm to predict the plurality of environmental data and sensor data of the plurality of CO₂ i-Bot sensors using the collected environmental and sensor data; and
determine an optimized number of CO₂ i-Bot sensors that minimizes a quantity of power consumption and maximizes an area of coverage of the hydrocarbon reservoir by the plurality of CO₂ i-Bot sensors using the trained machine learning algorithm.

16. The system of claim 15, wherein the plurality of environmental data comprises a CO₂ concentration, a pressure, a temperature, and a location, and wherein the plurality of sensor data comprises a signal quality, a reliability, and a power utilization.

17. The system of claim 15, wherein the monitoring for escaped CO₂ is for carbon sequestration or enhanced oil recovery (EOR).

18. The system of claim 15, wherein the machine learning algorithm is a long short-term memory (LSTM) network.

19. The system of claim 18, further comprising: an optimization framework into which the LSTM network is integrated, the optimization framework being configured for sensor selection and to determine the optimized number of CO₂ i-Bot sensors.

20. The system of claim 15, wherein communication among CO₂ i-Bot sensors is established using an Internet of Things (IoT) protocol.
